(19) United States
(12) Patent Application Publication
(10) Pub. No.: US 2006/0285240 A1
(43) Pub. Date: Dec. 21, 2006

(54) Environmental watch device for magnetic storage

(75) Inventor: Joseph K. Jurneke, Brighton, CO (US)

Correspondence Address: MORRISON & FOERSTER LLP, 425 MARKET STREET, SAN FRANCISCO, CA, 94105-2482, US

(73) Assignee: Quantum Corporation, San Jose, CA (US)

(21) Appl. No.: 11/155,735

(22) Filed: Jun. 16, 2005

(51) Int. Cl. G11B 15/04

(52) U.S. Cl. 360/60

(57) ABSTRACT

A tape media carrier has a tape medium for storing data, a rotatable element, such as a tape reel, bearing the tape medium, and a transducer within the tape media carrier. The transducer includes a sensor element and a detector for detecting at least one attribute of the sensor element that is responsive to ambient conditions within the tape carrier. The detector may be a strain gauge, in which case the measured attribute is strain. In another aspect, the sensor element may include marks disposed in at least one dimension. An optical detector in the media carrier may measure distance between the marks to represent the measured attribute of the sensor.

### BACKGROUND OF THE INVENTION

1. Field of the Invention

The present invention generally relates to the storage of data on a tape medium within a tape media carrier, and, more specifically, to monitoring environmental conditions within the tape media carrier that may affect storage performance.

2. Related Art

Environmental conditions within a tape media carrier, such as a tape cartridge or cassette, can unduly affect the writing and reading of data to the tape medium. Extremes of temperature or humidity can cause expansion of the tape, which, in turn, can result in data recovery errors when transferring data to or from the tape, or in positioning errors when servoing the tape drive to compensate for lateral tape motion.

Environmentally-induced expansion can also cause slackening, i.e., an undue reduction in the tension of the tape. Slackening can result in instantaneous velocity changes, inter layer slip, and loose wraps in the tape pack in the longitudinal direction of the tape, effectively reducing margin in the recording or reproduction performance of the tape system. It is desirable to be able to detect that the tape has been exposed to environmental extremes that may affect performance.

### SUMMARY OF THE INVENTION

The present invention provides a tape media carrier, such as a tape cartridge, having a tape medium for storing data, a rotatable element, such as a tape reel, bearing the tape medium, and a transducer within the tape media carrier. The transducer includes a sensor element and a detector for detecting at least one attribute of the sensor element that is responsive to ambient conditions within the tape carrier. The detector may be a strain gauge, in which case the measured attribute is strain. In another aspect, the sensor element may include marks disposed in at least one dimension. An optical detector in the media carrier may measure distance between the marks to determine dimensional change due to ambient conditions. The sensor element may have a response to ambient conditions similar to the response of the tape medium, and the sensor element may include a substrate similar or identical to that of the tape medium.

A tape drive for receiving the tape media carrier may include control logic for preventing writing of the tape medium in response to the detected attribute corresponding to an unsatisfactory condition, or the control logic may adjust tension on the tape medium in response to the detected at least one attribute. The tape drive may include an indicator for providing a human-perceivable indication in response to the detected attribute corresponding to reduced performance or an unsatisfactory condition.

In another embodiment, logic within the tape drive may use the measured distance between marks on the tape medium itself to determine ambient conditions within the media carrier. Control logic may prevent writing of the tape or adjust tension in a manner similar to that described above. Also, an indicator may provide an indication of unsatisfactory conditions or reduced performance based upon the measured distance between marks.

### BRIEF DESCRIPTION OF THE DRAWINGS

FIG. 1 depicts a tape cartridge having an auxiliary memory element operating with a tape drive in accordance with an embodiment of the present invention.

FIG. 2 illustrates a perspective view of an environmental transducer in accordance with an embodiment of the present invention.

FIGS. 3A and 3B illustrate front and side views of a transducer according to embodiments of the present invention.

FIG. 4 illustrates a servo system according to embodiments of the present invention.

### DETAILED DESCRIPTION OF THE INVENTION

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

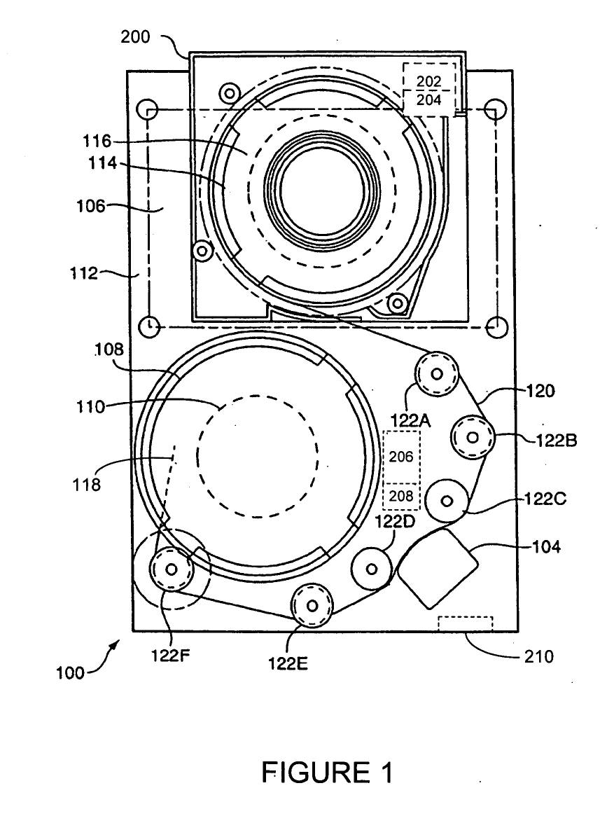

FIG. 1 illustrates an example of a tape-handling device, namely a tape drive 100, for use with a tape media carrier 200, such as a tape cartridge. In another embodiment, the tape media carrier may take the form of a tape cassette, in which case drive 100 would be modified accordingly. The tape drive 100 includes a tape head 104, a tape cartridge receiver 106, and an internal take-up reel 108 driven by a take-up reel drive motor 110. These elements are contained within a housing, typically including a base 112 and top cover portion (not shown). The tape cartridge 200 includes a supply reel 114 having magnetic tape medium 116 spooled thereon.

The tape medium 116 is provided to the tape drive 100 upon insertion of the tape cartridge 200 into the cartridge receiver 106. After insertion of the tape cartridge 200, an automatic loading process is performed in the tape drive 100. The loading process results in connecting, e.g., through a buckle connection, a tape cartridge leader 118, connected to the tape medium 116, and a take-up leader 120, connected to the take-up reel 108. Alternatively, the buckle and drive leader arrangement may be replaced with other methods of loading tape into the tape drive, as is known in the art. After connection of the tape cartridge leader 118 and take-up leader 120, the tape medium 116 is spooled off of the cartridge supply reel 114 onto the take-up reel 108 via the tape path defined by guide rollers 122A-F.

An environmental transducer 204 within the tape cartridge 200 may be coupled to an auxiliary memory element 202 according to embodiments of the invention. The auxiliary memory element 202 may comprise semiconductor memory to store metadata concerning the tape medium 116 and the data stored thereon, e.g., number of bytes written. The transducer 204 and auxiliary memory 202 may be placed in any convenient location within the media carrier.

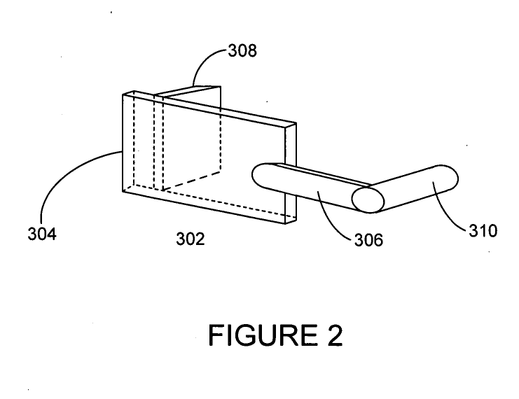

FIG. 2 illustrates the transducer 204, which includes a sensor element 304 and a strain gauge 306, in one embodiment. The sensor element 304 includes a sensing material having a response to ambient conditions, e.g., temperature and humidity, nearly identical to that of the tape medium 116. The sensor element 304 may be a polymeric-based film, have a substrate similar to that of the tape medium 116, or, in fact, comprise the same type of material as the tape medium 116. The substrate may be coated with coatings such as metallization layers, polymer-based layers, or combinations thereof. The sensor element 304 may be uniformly tensioned longitudinally in a manner to keep it from becoming slack within the range of acceptable ambient conditions and tensions appropriate for the application .

The sensor element 304 may be at least partially secured to an interior wall of the tape cartridge 200. For example, one end of the sensor element 304 may be secured by a standoff 308 to the interior wall, whereas another end of the sensor element 304 may be attached to the strain gauge 306, which itself is secured to the inner wall by a standoff 310.

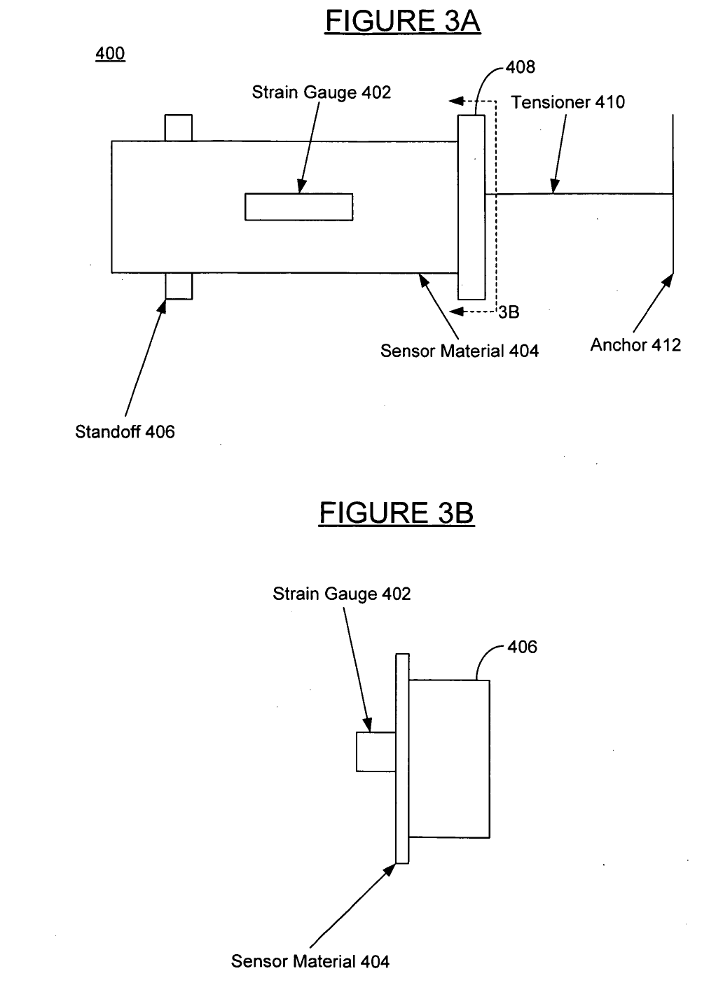

FIGS. 3A and 3B illustrate front and side views of an alternative embodiment of a transducer 400. A strain gauge 402 may be attached to the surface of a sensor element 404 to estimate strain on the surface of the sensor element. The sensor element 404 may be secured by a standoff 406 to the interior wall of the media carrier, whereas another end of the sensor element may be secured by a bar 408 pulled by a tensioner 410 (e.g., a wire). An anchor standoff 412 anchors the distal end of the tensioner 410 to maintain tension on the sensor element 404.

In either embodiment, the strain gauge measures the strain on the sensor element. As the sensor element expands and contracts due to ambient environmental conditions, the strain gauge provides an electrical output corresponding to the associated strain. The media carrier may employ one transducer to measure strain in one (e.g., longitudinal) dimension.

The transducers 204, 400 thus provide a surrogate indication of the condition of tape medium 116 without attempting to directly measure particular environmental parameters such as temperature or humidity. In addition, the transducers 204, 400 are not physically coupled with the tape medium 116 itself, and may occupy a portion of the cartridge 200 conveniently away from more crowded areas within the cartridge 200.

In another embodiment, the strain gauge 402 in transducer 400 may be replaced by an optical metrology sensor to measure the change in the longitudinal and/or lateral dimensions with environmental change. In that case, the sensor element may include finely placed marks in the longitudinal and/or lateral dimensions. The optical sensor would measure the distances between the marks in one or both dimensions.

The output of the transducer 204, 400 may be provided to the auxiliary memory 202, through an analog-to-digital converter (A/D) (not shown), which samples and stores the transducer output. A microprocessor, microcontroller or similar programmed logic circuit 206 within the tape drive 100 may be electrically coupled (by wire or wirelessly) or optically coupled to the auxiliary memory 202 in the tape cartridge 200, allowing the processor/controller 206 to access the data stored in the auxiliary memory 202. Another embodiment may employ a data interface, instead of auxiliary memory 202, to provide transducer measurements to the processor 206. In that embodiment, the A/D may be in the data interface or in the tape drive 100 associated with the processor 206.

The correlation between transducer output and acceptable/unacceptable operation may be stored in a look up table memory (“LUT”) 208 associated with the processor 206. Through empirical observation, in one embodiment the look-up table 208 would be set up to correlate a first range of transducer outputs corresponding to acceptable strain (or distance (in the optical case)) measurements to an indicator of satisfactory conditions, and a second range of transducer outputs corresponding to unacceptable strain (or distance) measurements to an indicator of unsatisfactory conditions. Those skilled in the art will recognize that the LUT may map to other sets of ranges as well. For example, a first range may indicate satisfactory performance, a second range may indicate conditions in which performance is reduced and a desired performance is not guaranteed, but the tape may still be operable, and a third range may indicate unsatisfactory performance requiring that tape operation should be halted, especially any operation that would involve recording information to the tape by means either magnetic or optical in nature.

The tape drive 100 may include an indicator 210, which may provide a simple indicator light or an alphanumeric display. The environmental transducer 204, 400 through the look-up table 208, may indicate an ambient condition that would cause unacceptable errors in reading from or writing to the tape medium 116. In that case, the processor 206 may actuate the indicator 210 to turn on a light, which, in turn would inform an operator that the tape cartridge 200 should be removed, the drive 100 should be moved to better ambient conditions, or a muffin fan or other cooling device should be checked for proper operation. Alternatively, as noted above, the display may indicate conditions in which a performance is reduced and a desired performance is not guaranteed, but the tape may still be operable.

Alternatively, or in addition to the display feature, the processor/controller 206 may prevent the tape head 104 from recording further data on the tape 116 until the transducer 204 again indicates satisfactory ambient conditions.

According to another option, the look up table 208 may store tension adjustment values corresponding to transducer output. Using the look up table 208, the processor/controller 206 may increase tension on the tape 116 in response to the transducer/look up table indicating a slackening of the tape, and decrease tension in response to the transducer/look up table indicating that environmental conditions are such that the effect on the tape medium 116 indicates that tension should be reduced. The processor 206 may increase or decrease tension by any means suitable to the architecture of the transport, including increasing or decreasing the electrical current to the tape reel drive motors

In another embodiment, the transducer may actually employ the tape medium 116 itself. In this case, marks (either magnetic or optical) may be placed on a surface or layer of the tape medium, and changes in relative position of these marks measured to determine changes in environment and device strain associated with applied tension from the tape drive. (In this manner, the marks serve the same purpose of providing distance measurements as in the optical sensor embodiment above.) Here, these marks may also serve a secondary function, that of track-following servo marks. Differential position measurement between at least two marks is required to assess change in dimension—either across web (laterally) or down web (longitudinally). A reduction in environmental effects may be achieved by increasing or lowering the applied tension to minimize the distortion in distance measurement from expected reference numbers.

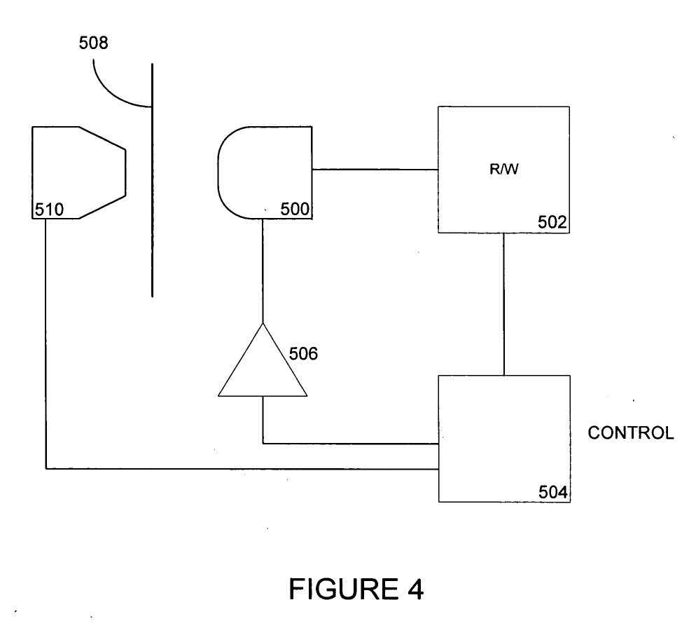

FIG. 4 illustrates a servo system according to embodiments of the present invention. The servo system may operate within a media drive, such as a tape drive 100. The system includes a magnetic recording head 500, read/write electronics 503 for respectively reading and writing signals from and to the head 500, a servo controller 504, and a positioning actuator 506 for laterally moving the recording head 500. The servo controller 504 may be embodied in processor 206 of the tape drive. The servo system may include an optical detector 510 for reading servo marks from the back of the tape.

Through the magnetic recording head 500 and the read/write electronics 502, the controller 504 may read magnetic servo marks from the front surface of the tape 508. Alternatively, through the optical detector 510, the controller 504 may read optical servo marks from the back surface of the tape 508. Using the measured servo marks, the controller 504 may determine a position of the head 500 with respect to one or more data tracks. The controller 504 compares the measured position to a desired position to cause the actuator 506 to move the head to the desired position.

The controller 504 may also use the servo marks, readable either from the front or back of the tape, to determine environmental changes to the tape medium by measuring the distance between at least two marks in the lateral and/or longitudinal dimensions, and comparing the measured distance(s) with known, acceptable distance(s), or by using a look-up table to match measured distance with the acceptable/unacceptable ranges similar to those described above. (Of course, the controller may measure a large number of distances between marks to obtain a statistically significant sample.) The acceptable distance(s) represent the distance between marks in each of the lateral and/or longitudinal dimensions corresponding to the tape being within an environment having acceptable ambient conditions for satisfactory data recording and playback.

Based upon the measured mark distance(s), the controller may provide indications to the user, prevent further recording, or adjust tape tension in ways similar to those described above with respect to the strain gauge measurements.

It will be appreciated that the above description for clarity has described embodiments of the invention with reference to different functional units. However, it will be apparent that any suitable distribution of functionality between different functional units may be used without detracting from the invention. Hence, references to specific functional units are only to be seen as references to suitable means for providing the described functionality rather than indicative of a strict logical or physical structure or organization.

The invention can be implemented in any suitable form including hardware, software, firmware or any combination of these. Different aspects of the invention may be implemented at least partly as computer software or firmware running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the claims. Additionally, although a feature may appear to be described in connection with a particular embodiment, one skilled in the art would recognize that various features of the described embodiments may be combined in accordance with the invention.

Moreover, it will be appreciated that various modifications and alterations may be made by those skilled in the art without departing from the spirit and scope of the invention. The invention is not to be limited by the foregoing illustrative details, but is to be defined according to the claims.

What is claimed is:

1. A tape media carrier comprising:
a tape medium for storing data;
a rotatable element bearing the tape medium; and
a transducer within the tape media carrier, the transducer including:
a sensor element; and
a detector for detecting at least one attribute of the sensor element that is responsive to ambient conditions.

2. The media carrier of claim 1, wherein the detector is a strain gauge and the at least one attribute is strain.

3. The media carrier of claim 1, wherein the sensor element includes markings disposed in at least one dimension, the at least one attribute relates to dimensional change of the sensor element, and the detector is an optical detector for measuring distance between the markings.

4. The media carrier of claim 1, wherein the sensor element has a response to ambient conditions similar to the response of the tape medium.

5. The media carrier of claim 1, wherein the sensor element is a polymeric based film.

6. The media carrier of claim 1, wherein the sensor element includes a substrate similar to that of the tape medium.

7. The media carrier of claim 1, wherein the sensor element is not disposed on the rotatable element.

8. The media carrier of claim 1, wherein the media carrier is a tape cartridge.

9. A tape drive for receiving the tape media carrier of claim 1, the tape drive comprising:
control logic for preventing writing of the tape medium in response to the detected at least one attribute corresponding to an unsatisfactory condition.

10. A tape drive for receiving the tape media carrier of claim 1, the tape drive comprising:
an indicator for providing a human-perceivable indication in response to the detected at least one attribute corresponding to an unsatisfactory condition.

11. A tape drive for receiving the tape media carrier of claim 1, the tape drive comprising:
an indicator for providing a human-perceivable indication in response to the detected at least one attribute corresponding to reduced performance.

12. A tape drive for receiving the tape media carrier of claim 1, the tape drive comprising:
control logic for adjusting tension on the tape medium in response to the detected at least one attribute.

13. The media carrier of claim 1, further comprising an auxiliary memory, readable by a tape drive, for storing the detected at least one attribute.

14. A tape drive operable to receive a tape media carrier, wherein the tape media carrier includes a tape medium upon which is disposed markings in at least one dimension, the tape drive comprising:
a detector for measuring distance between the markings; and
logic for providing an output related to ambient conditions within the media carrier based upon the measured distance.

15. The tape drive of claim 14, further comprising control logic for preventing writing of the tape medium in response to the output corresponding to an unsatisfactory condition.

16. The tape drive of claim 14, further comprising control logic for adjusting tension on the tape medium in response to the output.

17. The tape drive of claim 14, further comprising an indicator for providing a human-perceivable indication in response to the output corresponding to unsatisfactory conditions.

18. The tape drive of claim 14, further comprising an indicator for providing a human-perceivable indication in response to the output corresponding to reduced performance.

19. A method for sensing ambient conditions in a tape media carrier, the tape media carrier including a tape medium, the method comprising:
at least one attribute of a sensor element responding to the ambient conditions, wherein the sensor element resides within the carrier; and
detecting the at least one attribute.

20. The method of claim 19, wherein detecting comprises detecting strain.

21. The media carrier of claim 19, wherein detecting comprises measuring distance between markings disposed on the sensor element in at least one dimension.

22. The method of claim 21, wherein the tape medium comprises the sensor element.

23. The method of claim 19, wherein responding comprises responding to the ambient conditions in a manner similar to that of the tape medium.

24. The method of claim 19, further comprising preventing writing of the tape medium in response to the detected at least one attribute corresponding to an unsatisfactory condition.

25. The method of claim 19, further comprising providing a human-perceivable indication in response to the detected at least one attribute corresponding to an unsatisfactory condition.

26. The method of claim 19, further comprising providing a human-perceivable indication in response to the detected at least one attribute corresponding to reduced performance.

27. The method of claim 19, further comprising adjusting tension on the tape medium in response to the detected at least one attribute.

28. The method of claim 19, further comprising storing the detected at least one attribute in an auxiliary memory readable by a tape drive.
